(19) United States
(12) Patent Application Publication
(10) Pub. No.: US 2012/0006903 A1
(43) Pub. Date: Jan. 12, 2012

(54) RFID TAG

(76) Inventor: CHIN HUA LIN, TAOYUAN COUNTY (TW)

(21) Appl. No.: 13/097,319

(22) Filed: Apr. 29, 2011

(30) Foreign Application Priority Data
Jul. 6, 2010 (TW) 099122106

(51) Int. Cl. G06K 19/077

(52) U.S. Cl. 235/492

(57) ABSTRACT

An RFID tag includes a grounding cover, an electric field coupling cover and an RFID module. The grounding cover and the electric field coupling cover are conductive and the electric field coupling cover is installed opposite to the grounding cover. The RFID module is installed between the grounding cover and the electric field coupling cover. The RFID module includes an RFID chip and an electric field coupling unit. The electric field coupling unit is electrically connected to the RFID chip for receiving the driving signal and sending the identification signal, wherein an enhanced electric field is generated between the electric field coupling cover and the grounding cover once the electric field coupling cover receives at least one signal selected from the group of the driving signal and the identification signal so that the signal selected from the group of the driving signal and the identification signal is enhanced.

This application claims the benefits of the Taiwan Patent Application Serial No. 099122106 filed on Jul. 6, 2010, the subject matter of which is incorporated herein by reference.

### BACKGROUND OF THE INVENTION

1. Field of the Invention

The present invention relates to an RFID tag, and more particularly, relates to an RFID tag including an electric field coupling cover.

2. Description of the Prior Art

The technology of radio frequency identification (hereafter: RFID), also called electronic tag, is a communications technology for identifying a certain target and reading/writing related data via radio signal. One of the advantages of the technology of RFID is that targets are identifiable without mechanical or optical contacts.

The technology of RFID includes two parts: one is an RFID reader and the other is an RFID tag. The RFID reader is for transmitting electromagnetic wave signals to the RFID tag; an identification signal reflects and is sent back to the RFID reader for identification.

There are three types of RFID tags depending on whether a power supply is built in: active RFID tags, semi-active RFID tags and passive RFID tags. Among them, passive RFID tags are not built in with a power supply and the circuit inside can only be driven via received electromagnetic waves outside. Once the passive RFID tag receives enough intensity of signals, it reflects and sends an identification signal to the RFID reader.

Since a passive RFID tag is not built in with a power supply, it has advantages such as lower price and smaller size; therefore, it is the most widely used in the market in terms of electronic toll collection, warehouse management, logistics management, locating objects out of sight, etc.

Moreover, RFID tags are also categorized in four types according to their working frequency—low frequency (LF) tags, high frequency (HF) tags, ultrahigh frequency (UHF) tags and microwave (MW) tags, wherein UHF refers to working frequency ranging from 860 MHz to 960 MHz. The higher the working frequency is, the higher the transmission rate of signals is. As a result, UHF tags win people's attention mostly and are mainly used in fields of logistics and objects locator.

However, passive RFID tags in the prior art are planar RFID tags on the basis of dipole antennas; gain of its receiving and transmitting signals is too low and is affected easily by the environment.

Besides, a UHF RFID tag is very sensitive to metal and liquid surroundings due to its characteristic of backscatter of electromagnetic wave. When the UHF RFID tag is applied on surfaces of metal, liquid or earth, the electromagnetic wave will be highly and seriously interfered and is absorbed to drive its RFID chip; also, identification signals reflected is not enough for being sent to its RFID reader.

One of the conventional ways for solving the above-mentioned problems includes: separating the RFID tag from the surface of metal for a distance and adding a layer for collecting waves on the back of the RFID tag in order to decrease the interference in the RFID tag caused by the metal products. As s result, the RFID tag can only be read from its front side. Hence, the conventional way can not satisfy the market needs and can not really solve the problem.

Another conventional way is applying a ceramic capacitor with micro-stripe antennas. The size of an RFID tag is shrunk because of high dielectric coefficient characteristic of ceramics. However, since the ratio value of its central frequency to bandwidth of this conventional RFID tag is very high, the RFID tag usually can only be applied in a range of narrow-bandwidth. Moreover, only a radiation surface inside the RFID tag can be read, which does not satisfy the market needs.

In fact, environments for storing and managing materials and products are usually in great demand; i.e., steel bars are stacked disorderly; bottles of gas in different sizes are stored together and etc. Obviously, the electromagnetic wave signals for reading the RFID tags are mostly interfered, reflected and absorbed, and the RFID tags are also likely to be damaged, which make it difficult to read the RFID tags.

In conclusion, passive RFID tags in the prior art are planar RFID tags on the basis of dipole antennas; gain of its receiving and transmitting signals is too low and affected easily by the environment. The UHF RFID tag is very sensitive to metal and liquid surroundings due to its characteristic of backscatter of electromagnetic wave. When the UHF RFID tag is applied on surfaces of metal, liquid or earth, the electromagnetic wave will be highly and seriously interfered and is absorbed to drive its RFID chip; also, identification signals reflected is not enough for being sent to its RFID reader. Although conventional RFID tags with additional layers for collecting waves or conventional ceramic capacitor with micro-stripe antennas can reduce the interference on the surface of metal, the reading range is limited.

### SUMMARY OF THE INVENTION

An RFID tag including an electric field coupling cover is provided in accordance with the present invention. The RFID tag of the present invention enhances the signal strength of electromagnetic wave signals and improves the robustness thereof via an enhanced electric field generated between the electric field coupling cover and a grounding cover.

The RFID tag is provided for receiving a driving signal and sending an identification signal to an RFID reader according to the driving signal. The RFID tag of the present invention includes the grounding cover, the electric field coupling cover and an RFID module; the grounding cover and the electric field coupling cover respectively include conductive materials. Once the electric field coupling cover is affected by electromagnetic waves and generates electric currents, an electric field is then generated between the grounding cover and the electric field coupling cover. The RFID module is installed inside the electric field and couples energy inside the electric field until the energy is strong enough for reading.

The electric field coupling cover is installed opposite to the grounding cover and cooperatively defining there between a vacant space, which becomes a resonance cavity for the electric field. The RFID module is installed inside the resonance cavity; that is, the RFID module is sandwiched between the electric field coupling cover and the grounding cover. An enhanced electric field is generated between the electric field coupling cover and the grounding cover when the electric field coupling cover receives at least one signal selected from the group of the driving signal and the identification signal so that at least one signal selected from the group of the driving signal and the identification signal is enhanced. The RFID module includes an RFID chip and an electric field coupling unit, the electric field coupling unit electrically connecting the RFID chip for receiving the driving signal and sending the identification signal.

Moreover, according to an embodiment of the present invention, the electric field coupling cover further includes a grounding part, which is electrically connected to the grounding cover, and a coupling part, which extends from the grounding part. The RFID module is placed between the electric field coupling cover and the grounding cover and the enhanced electric field is generated between the coupling part and the grounding cover when the electric field coupling cover receives at least one signal selected from the group of the driving signal and the identification signal so that the signal selected from the group of the driving signal and the identification signal is enhanced.

According to an embodiment of the present invention, the grounding part is electrically connected to the grounding cover via at least one selected from the group consisting of at least a wire and at least a metal sheet.

According to an embodiment of the present invention, the electric field coupling unit includes an inductor and a capacitor, and the inductor, the capacitor and the RFID chip are connected to one another in parallel, wherein the capacitor includes a plate capacitor.

According to an embodiment of the present invention, the RFID tag further includes an insulating case, which is installed between the electric field coupling cover and the grounding cover, wherein the insulating case includes a plastic material.

Compared with a conventional RFID tag with additional layers for collecting waves or a conventional ceramic capacitor with micro-stripe antennas, the RFID tag of the present invention increases the signal strength of the driving signal or the identification signal by providing the electric field coupling cover for generating the enhanced electric field between the electric field coupling cover and the grounding cover once the driving signal or the identification signal is received. As a result, the RFID tag of the present invention provides a larger reading range; in embodiments such as the RFID tag is applied in stacked metal objects, it remains readable even when only few driving signal or identification signal are received. Besides, since the thickness of the electric field coupling cover does not affect the generation of the enhanced electric field, nor the reading ability of the RFID tag, the RFID tag can be reinforced by adding the thickness of the electric field coupling cover so that the RFID tag has better crashworthiness.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a schematic view of the first embodiment of an RFID tag according to the present invention.

FIG. 2 is a schematic view of the second embodiment of the RFID tag according to the present invention.

FIG. 3 is a circuit diagram showing an RFID module of the present invention.

FIG. 4 is a schematic view of the third embodiment of the RFID tag according to the present invention.

FIG. 5 is a schematic view of the fourth embodiment of the RFID tag according to the present invention.

FIG. 6 shows the RFID tag on a bottle gas according to the present invention; and

FIG. 7 shows the RFID tag on an H-shaped steel bar according to the present invention.

### DETAILED DESCRIPTION OF THE PREFERRED EMBODIMENTS

The present invention relates to an RFID tag, and more particularly, relates to an RFID tag including an electric field coupling cover. Preferred embodiments of the present invention are disclosed in the following paragraphs for better understanding of the present invention. However, the scope of the present invention should not be limited only to the structure of the disclosed embodiments.

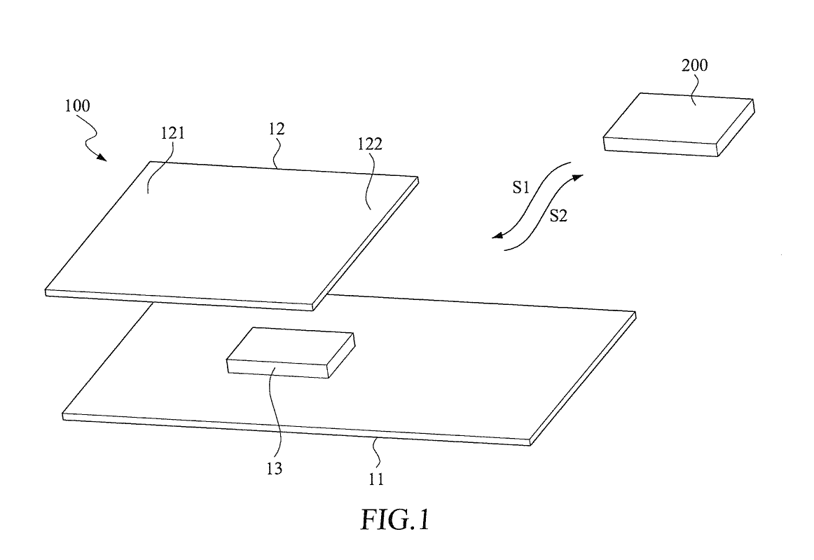

Referring to FIG. 1, FIG. 1 is a schematic view of the first embodiment of an RFID tag according to the present invention. The RFID tag 100 is for receiving a driving signal S1 and sending an identification signal S2 to an RFID reader 200 according to the driving signal S1. The RFID tag 100 accordingly includes a grounding cover 11, an electric field coupling cover 12 and an RFID module 13.

The grounding cover 11 includes a plastic material and in practice can be installed on the surface of metal objects or other objects providing ground connections. The electric field coupling cover 12 also includes a plastic material and is installed opposite to the grounding cover 11; a vacant space is defined between the grounding cover 11 and the electric field coupling cover 12.

The RFID module 13 is installed between the grounding cover 11 and the electric field coupling cover 12. The RFID module 13 includes an identification chip and an electric field coupling unit. The electric field coupling unit is electrically connected to the RFID chip for receiving the driving signal S1 and sending the identification signal S2, wherein an enhanced electric field is generated between the electric field coupling cover 12 and the grounding cover 11 once the electric field coupling cover 11 receives at least one signal selected from the group of the driving signal S1 and the identification signal S2 so that signal selected from the group of the driving signal S1 and the identification signal S2 is enhanced.

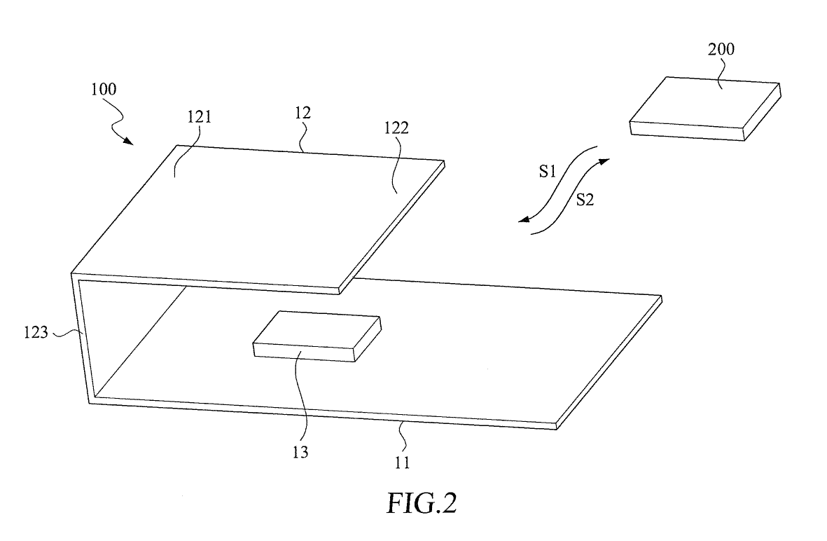

Referring to FIG. 2, FIG. 2 is a schematic view of the second embodiment of the RFID tag according to the present invention. FIG. 2 is different from FIG. 1, wherein the electric field coupling cover 12 includes a grounding part 121 and a coupling part 122. The grounding part 121 is electrically connected to the grounding cover 11 and the coupling part 122 extends from the grounding part 11; the enhanced electric field is generated between the coupling part 122 and the grounding cover 11 once the electric field coupling cover 12 receives at least one signal selected from the group of the driving signal S1 and the identification signal S2 so that the—signal selected from the group of the driving signal S1 and the identification signal S2 is enhanced.

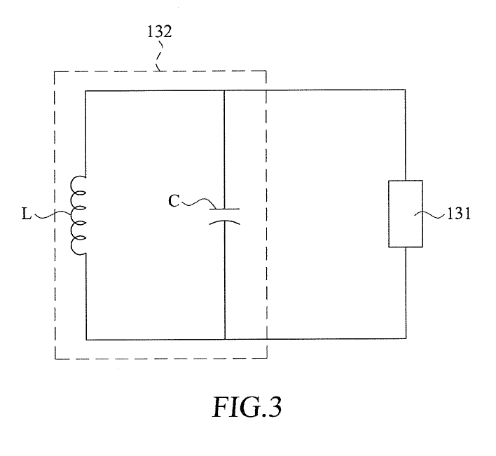

Referring to FIG. 3, FIG. 3 is a circuit diagram showing the RFID module 13 of the present invention, wherein an electric field coupling unit 132 includes an inductor L and a capacitor C, and the inductor L, the capacitor C and an RFID chip 131 are connected to one another in parallel, wherein the capacitor C includes a plate capacitor. According to FIG. 3, the capacitor C receives electromagnetic wave energy and then sends it to the RFID chip 131. When the RFID chip 131 is installed on the surface of a metal, and if the surface of the metal is affected by the electromagnetic wave energy and surface currents are generated, the inductor L can pull partial currents so that the energy of the RFID chip 131 is enhanced and reading ability of the RFID chip 131 is also enhanced.

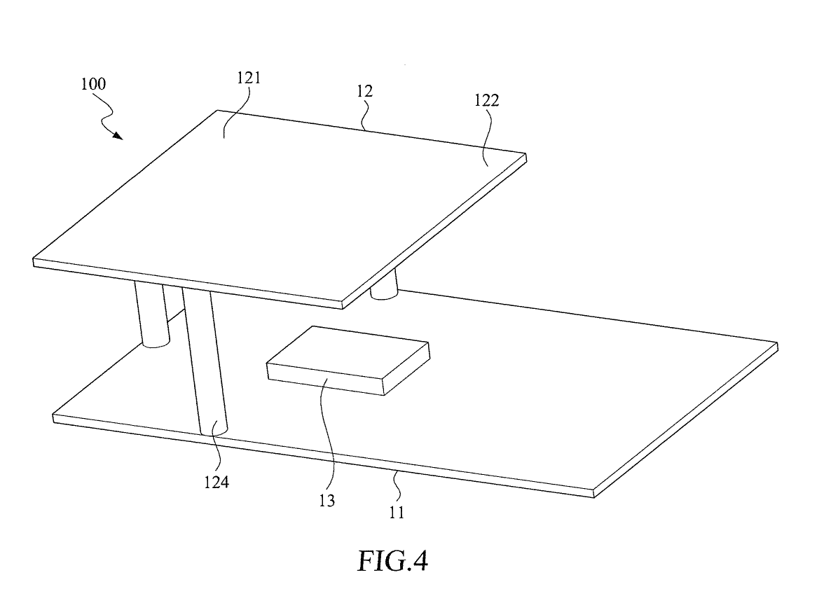

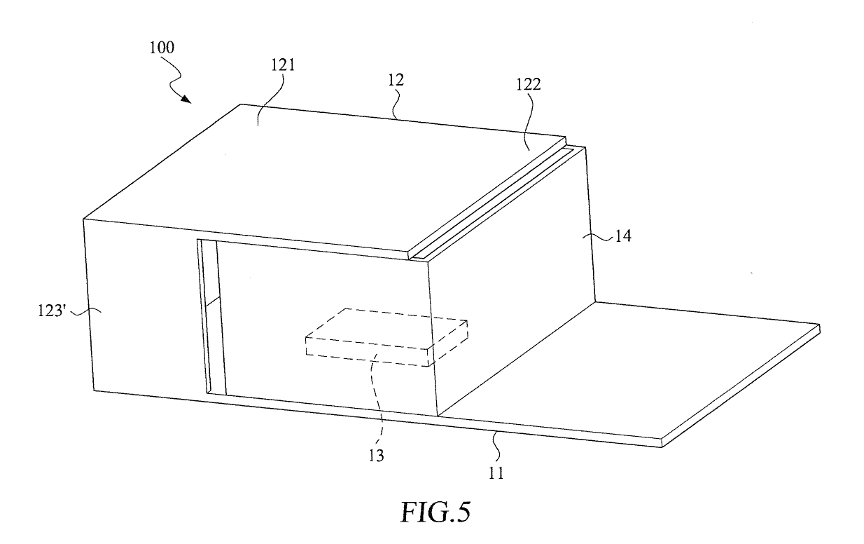

Referring to FIGS. 4 and 5, wherein FIG. 4 is a schematic view of the third embodiment of the RFID tag according to of the present invention; and FIG. 5 is a schematic view of the fourth embodiment of the RFID tag according to the present invention. In FIG. 2, the electric field coupling cover 12 is electrically connected to an end of the grounding cover 11 via a metal sheet 123. Apart from this, the electric field coupling cover 12 can also be electrically connected to the grounding cover 11 via a wire 124. Further, the electric field coupling cover 12 can be electrically connected to multiple ends of the grounding cover 11 via a metal sheet 123′. The main feature is that the coupling part 122 needs to be extended from the grounding part 121 the greater length and area the coupling part 122 extends from the grounding part 121, the better the signal strength of the driving signal S1 and the identification signal S2 becomes.

Furthermore, the RFID tag 100 further includes an insulating case 14. The insulating case 14 is installed between the electric field coupling cover 12 and the grounding cover 11. Preferably, the insulating case includes a plastic material, which prevents the result that the enhanced electric field can not be generated due to electric conductance caused by objects contacting the coupling part 122 and the grounding cover 11 once the objects are stacked and thus prevents the reading ability of the RFID tag 100 from being affected.

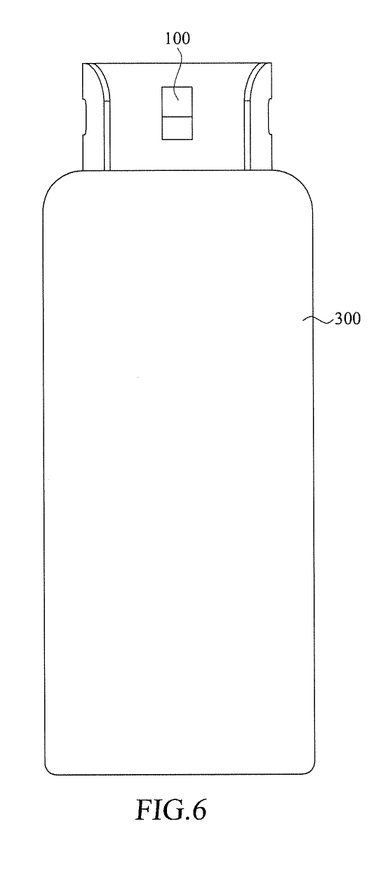

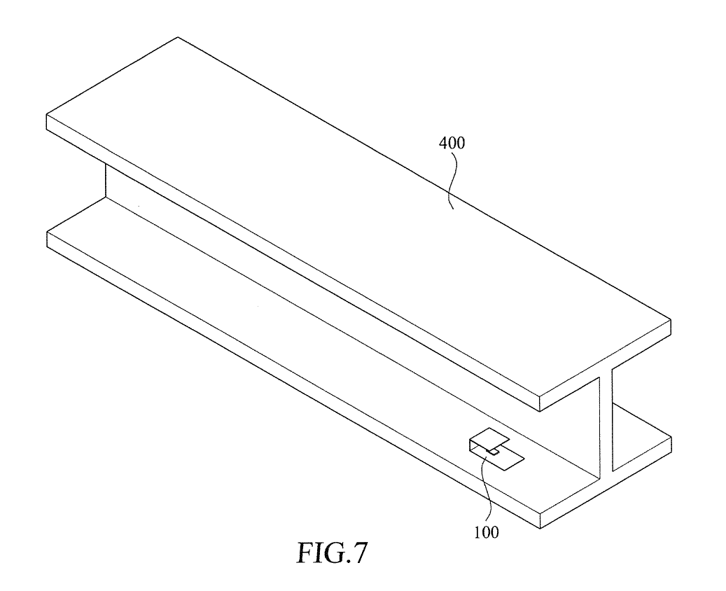

Since the RFID module 13 of the RFID tag 100 of the present invention is installed between the electric field coupling cover 12 and the grounding cover 11, the RFID module 13 is well protected. In practice, the RFID tag 100 can be installed in any places. Referring to FIGS. 6 and 7, wherein FIG. 6 shows the RFID tag on a bottle gas according to the present invention while FIG. 7 shows the RFID tag on an H-shaped steel bar according to the present invention. Most materials and products in the market, such as a bottle gas 300 or an H-shaped steel bar, need to be organized and managed according to their life time. Although the conventional RFID tag with additional layers for collecting waves or the conventional ceramic capacitor with micro-stripe antennas can be used for managing and detecting the mentioned materials and products, the conventional technology can only check them one by one. However, if the materials and products are stacked together, the electromagnetic waves will become weak for being reflected or absorbed; further, the conventional technology can only read the materials and products from their front side, which makes management difficult. On the contrary, the RFID tag 100 according to the present invention can read materials and products such as the bottle gas 300 or the H-shaped steel bar not only from their front side. When materials and products are stacked, as long as the electromagnetic wave signals reflects and reaches the RFID tag 100, the enhanced electric field is generated between the coupling part 122 and the grounding cover 11 so as to enhance the signal strength for the RFID module 13 to read.

In conclusion, compared with the conventional RFID tag with additional layers for collecting waves or the conventional ceramic capacitor with micro-stripe antennas, the RFID tag 100 of the present invention increases the signal strength of the driving signal S1 or the identification signal S2 by providing the electric field coupling cover 12 for generating the enhanced electric field between the electric field coupling cover 12 and the grounding cover 11 once the driving signal S1 or the identification signal S2 is received. As a result, the RFID tag 100 of the present invention provides a larger reading range; in embodiments such as the RFID tag 100 is applied in stacked metal objects, it remains readable even when only few driving signal S1 or identification signal S2 are received. Besides, since the thickness of the electric field coupling cover 12 does not affect the generation of the enhanced electric field, nor the reading ability of the RFID tag 100, the RFID tag 100 can be reinforced by adding the thickness of the electric field coupling cover 12 so that the RFID tag 100 has better crashworthiness.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An RFID tag for receiving a driving signal and sending an identification signal to an RFID reader according to the driving signal, the RFID tag comprising:
a grounding cover including a conductive material;
an electric field coupling cover installed opposite to the grounding cover, the electric field coupling cover including a conductive material; and
an RFID module installed between the grounding cover and the electric field coupling cover, and including:
an RFID chip, and
an electric field coupling unit electrically connected to the RFID chip for receiving the driving signal and sending the identification signal;
wherein, an enhanced electric field is generated between the electric field coupling cover and the grounding cover once the electric field coupling cover receives at least one signal selected from the group of the driving signal and the identification signal so that the signal selected from the group of the driving signal and the identification signal is enhanced.

2. The RFID tag according to claim 1, wherein the electric field coupling cover further includes:
a grounding part electrically connected to the grounding cover; and
a coupling part extending from the grounding part;
wherein, the enhanced electric field is generated between the coupling part and the grounding cover once the electric field coupling cover receives at least one signal selected from the group of the driving signal and the identification signal so that the signal selected from the group of the driving signal and the identification signal is enhanced.

3. The RFID tag according to claim 2, wherein the grounding part is electrically connected to the grounding cover via at least one selected from the group consisting of at least a wire and at least a metal sheet.

4. The RFID tag according to claim 1, wherein the electric field coupling unit includes an inductor and a capacitor, the inductor, the capacitor and the RFID chip being connected to one another in parallel.

5. The RFID tag according to claim 1, wherein the capacitor includes a plate capacitor.

6. The RFID tag according to claim 1, further comprising an insulating case, the insulating case being installed between the electric field coupling cover and the grounding cover.

7. The RFID tag according to claim 6, wherein the insulating case includes a plastic material.
